(19) United States
(12) Patent Application Publication
(10) Pub. No.: US 2009/0046042 A1
(43) Pub. Date: Feb. 19, 2009

(54) Drive Method for Reducing the Power Consumption of a Flat Display

(75) Inventors: Tsung-Ting Tsai, Hsin-Chu (TW); Li-Wei Shih, Hsin-Chu (TW); Chih-Lung Lin, Tainan (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/972,845

(22) Filed: Jan. 11, 2008

(30) Foreign Application Priority Data
Aug. 15, 2007 (TW) 96130204

(51) Int. Cl. G09G 3/30; G09G 5/02

(52) U.S. Cl. 345/77; 345/604

(57) ABSTRACT

The present invention provides a method to reduce the power consumption. The method comprises these steps. First, the RGB gray levels of a pixel are decided. Then, the RGB gray level values are transformed to XYZ tristimulus values. The XYZ tristimulus values are transformed to L*a*b* values. Next, the L*′a*′b*′ values are determined based on an acceptable color difference range. The color difference between the L*′a*′b*′ and the L*a*b* is in the color difference range. Finally, the L*′a*′b*′ values are transformed to X′Y′Z′ values and the X′Y′Z′ values are transformed to R′G′B′ gray level values.

### RELATED APPLICATIONS

This application claims priority to Taiwan Patent Application Serial Number 96130204, filed Aug. 15, 2007, which is herein incorporated by reference.

### FIELD OF THE INVENTION

The present invention relates to an operation method, and more particularly to an operation method for an organic light-emitting device.

### BACKGROUND OF THE INVENTION

Devices that integrate organic light-emitting devices (hereinafter abbreviated to OLED) have superior properties such as spontaneous light emissions, wider viewing angles, faster response speeds and the like. The conventional OLED structure is based on a stack of a first electrode preferably formed on glass, an organic light-emitting layer comprising a hole transport layer, a light-emitting layer and an electron transport layer formed on the first electrode, and a second electrode as an upper electrode with a low work function formed on the organic light-emitting layer. Then, by applying a voltage of several volts between the first and the second electrodes, holes and electrons are injected into the hole transport layer and the electron transport layer, respectively. Next, excitons are formed in the light-emitting layer where the holes and the electrons are combined. Finally, light is emitted from the light-emitting layer when the excitons formed return to their ground states. In the case of a so-called bottom emission type using the first electrode which is transparent, the emitted light passes the first electrode and is taken out from the back of the substrate.

However, the life-time of the material of the organic light-emitting layer limits the application range of OLED, especially the life-time of blue color material, which is much less than that of red and green color material. Therefore, the life-time of the OLED is the main issue needed to be improved.

### SUMMARY OF THE INVENTION

One of the purposes of the present invention is to adjust the gray level value to save the power consumption of the red light, green light and blue light to improve the life-time of OLED.

Accordingly, one aspect of the present invention is directed to a method for reducing the power consumption. The method comprises these steps. First, the RGB gray levels of a pixel are decided. Then, the RGB gray level values are transformed to XYZ tristimulus values. The XYZ tristimulus values are transformed to L*a*b* values. Next, the L*′a*′b*′ values are determined based on an acceptable color difference range. The color difference between the L*′a*′b*′ and the L*a*b* is in the color difference range. Finally, the L*′a*′b*′ values are transformed to X′Y′Z′ values and the X′Y′Z′ values are transformed to R′G′B′ gray level values.

In one embodiment, the method further comprises calculating the saving power consumption of applying the R′G′B′ gray level values to replace the RGB gray level values to the pixels.

In one embodiment, the foregoing steps are repeatedly performed to get optimum R′G′B′ gray level values that can save the maximum power consumption in the acceptable color difference range. Then, this optimum R′G′B′ gray levels are applied to the pixels.

Accordingly, the method of the present invention can reduce the power consumption of OLED and the life-time of OLED is also improved.

### BRIEF DESCRIPTION OF THE DRAWINGS

FIG. 1 illustrates a flow chart of how to adjust the gray level according to the preferred embodiment of the present invention.

FIG. 2 illustrates a flow chart of how to adjust the L*, a* and b* values according to the preferred embodiment of the present invention.

### DETAILED DESCRIPTION OF THE PREFERRED EMBODIMENT

According to the spirit of the present invention, the gray level values can be adjusted based on an acceptable color difference range to reduce the power consumption to improve the life-time of the OLED.

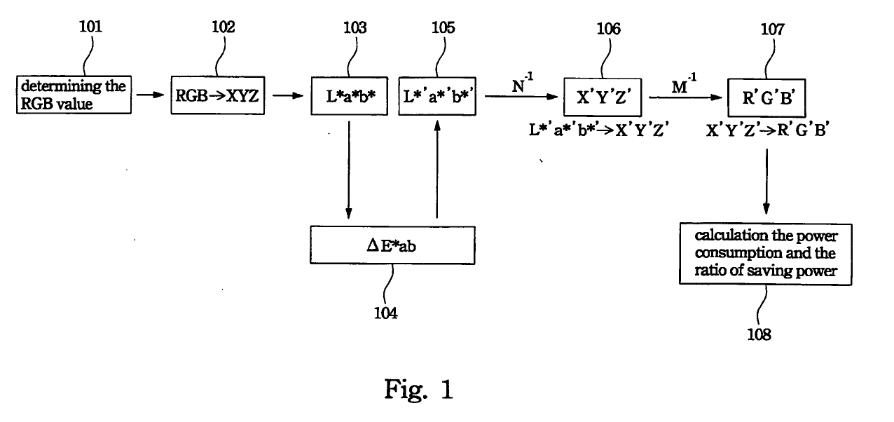

FIG. 1 illustrates a flow chart showing how to adjust the gray level according to the preferred embodiment of the present invention. In step 101, the RGB gray level values are determined. In step 102, performing mathematical transformations to transform the RGB gray level values into XYZ tristimulus values. The tristimulus values X, Y, and Z are fundamental red, green and blue, respectively, and they are calculated using the CIE 1931 XYZ color matching functions. The roughly red, green and blue are not physically real color, but rather a set of made up color. The mathematical transformations from the RGB gray level values to XYZ tristimulus values are as follows:

$$r = \{ \begin{matrix}R / 12.92 & R \leq 0.04045 \\ {( ( R + 0.055 ) / 1.055 )}^{2.4} & R > 0.04045\end{matrix} \\ g = \{ \begin{matrix}G / 12.92 & G \leq 0.04045 \\ {( ( G + 0.055 ) / 1.055 )}^{2.4} & G > 0.04045\end{matrix} \\ b = \{ \begin{matrix}B / 12.92 & B \leq 0.04045 \\ {( ( B + 0.055 ) / 1.055 )}^{2.4} & B > 0.04045\end{matrix} \\ [ \begin{matrix}X & Y & Z\end{matrix} ] = [ \begin{matrix}r & g & b\end{matrix} ] [ M ]$$

In step 103, to further improve and unify color evaluations, The XYZ tristimulus values are transformed to L*a*b* values based on a color difference formula according to CIE1976Lab color system (Commission Internationale de L'Eclairage, CIE) as follows.

$$\{ \begin{matrix}{L}^{*} = 116 {( Y / {Y}_{0} )}^{1 / 3} - 16 \\ {a}^{*} = 500 [ {( X / {X}_{0} )}^{1 / 3} - {( Y / {Y}_{0} )}^{1 / 3} ] \\ {b}^{*} = {200 [ {( Y / {Y}_{0} )}^{1 / 3} - {( Z / {Z}_{0} )}^{1 / 3} ]}_{Y / {Y}_{0} > 0.01}\end{matrix}$$

X, Y and Z are tristimulus values of object. X₀, Y₀ and Z₀ are tristimulus values of CIE standard observer. L* represents the lightness of the color, wherein L*=0 yields black and L*=100 indicates white. The a* and b* are the chroma. The a* position is between red/magenta and green. Negative value of a* indicates green. Positive value of a* indicates magenta. The b* position is between yellow and blue. Negative value of b* indicates blue. Positive value of b* indicates yellow.

In step 104 and 105, the L*a*b* values are adjusted to the L*′a*′b*′ values, wherein the color difference between the L*′a*′b*′ and the L*a*b* is in an acceptable color difference range. Then, a set of optimum L*′a*′b*′ values are determined to replace the original set of L*a*b* values. This set of L*′a*′b*′ values consumes the minimum power.

The color difference uses numerical analysis to represent the difference in chroma. When two sets of L*a*b* values are respectively defined to two samples to represent their colors, the total color difference and the Chroma difference are represented as follows:

Lightness difference: ΔL*=L*′−L*

Chroma difference: Δa*=a*′−a*, Δb*=b*′−b*

Total color difference: ΔE*ab=[(ΔL*)²+(Δa*)²+(Δb*)²]^{1/2}

ΔE*ab value rules the color range that human eyes can recognized. Difference ΔE*ab values have different color effect for human eyes.

When ΔE*ab value is located between 1.6 and 3.2, human eyes can not recognize the color difference between the two samples.

When ΔE*ab value is located between 3.2 and 6.5, a person skilled in the art can recognize the color difference between the two samples. However, general person still cannot recognize the color difference between the two samples.

When ΔE*ab value is located between 6.5 and 13, the color difference between the two samples can be recognized by human eyes but the color tone is same.

When ΔE*ab value is located between 13 and 25, the color tone difference and the color relationship between the two samples can be recognized by human eyes.

When ΔE*ab value is over 25, the two samples have different color.

According to the present invention, the acceptable total color difference range (ΔE*ab value) is defined to be located between 3 and 6.

According to the preferred embodiment of the present invention, since human eyes are sensitive to brightness, the brightness (L* value) is adjusted by positive and negative 0.5 steps. The chroma (a* value and b* value) are adjusted by positive and negative 1 steps. By the foregoing adjusted method, a set of optimum L*′a*′b*′ values whose total color difference range corresponding to the original L*a*b* values is located between 3 and 6 are determined to replace the original L*a*b* values.

In step 106 the L*′a*′b*′ values are transformed to X′Y′Z′ values. Then, in step 107, the X′Y′Z′ values are transformed to R′G′B′ gray level values. The original RGB gray level values are replaced by the R′G′B′ gray level values. In step 108, the power consumption value of applying the R′G′B′ gray level values to pixels are calculated and compared with the power consumption value of applying the original RGB gray level values to pixels. The power consumption saving ratio is recorded and the foregoing steps are repeatedly performed to get a set of optimum R′G′B′ gray level values that can reduce the power consumption most within the acceptable color difference range. Then, this optimum R′G′B′ gray levels are applied to the pixels.

Accordingly, this set of optimum R′G′B′ gray level values is searched based on the defined acceptable color difference range. Therefore, the color difference is not recognized by human eyes. The method can reduce the power consumption of OLED and the life-time of OLED is also improved.

In an embodiment, for an OLED, when the gray level value is 255, the power consumption of blue color light is 0.00816 mW, the power consumption of red color light is 0.00456 mW, and the power consumption of green color light is 0.00276 mW. In other words, the blue color light consumes the maximum power. Therefore, the preferred adjusted method reduces the gray level value of blue color light.

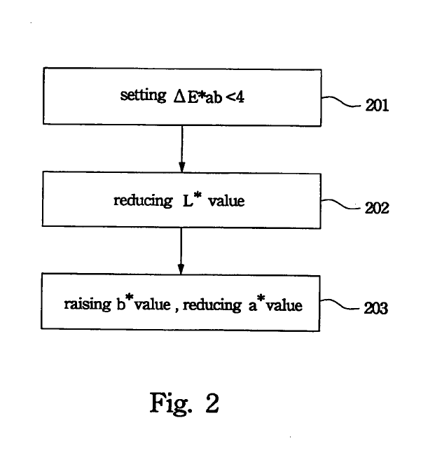

FIG. 2 illustrates a flow chart to adjust the L*, a* and b* values according to the preferred embodiment of the present invention. In step 201, the ΔE*ab value is set to less than 4. That is to adjust a set of L*′a*′b*′ values whose total color difference range corresponding to the original L*a*b* values is 4. In step 202, since human eyes are sensitive to brightness, the brightness (L* value) is adjusted. In step 203, the chroma (b* value) is adjusted to reduce the power consumption of blue color light. Finally, the chroma (a* value) is adjusted to reduce the whole power consumption of OLED.

Accordingly, for an OLED, the life-time of blue color light is much less than that of red color light and green color light. The method of the present invention can reduce the power consumption of blue color light and improve its life-time.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A method for reducing the power consumption for a flat display, comprising:
determining RGB gray level values of a pixel;
transforming the RGB gray level values to XYZ tristimulus values;
transforming the XYZ tristimulus values to L* value, a* value and b* value;
setting an acceptable color difference range;
determining L*′ value, a*′ value and b*′ value, wherein color difference between the L*′ value, a*′ value and b*′ and the L* value, a* value and b* is in the acceptable color difference range;
transforming the L*′ value, a*′ value and b*′ value to X′Y′Z′ tristimulus values; and
transforming the X′Y′Z′ tristimulus values to R′G′B′ gray level values.

2. The method of claim 1, further comprising:
calculating the power consumption saving of applying the R′G′B′ gray level values corresponding to the RGB gray level values to the pixels;
performing the steps of claim 1 repeatedly to get the R′G′B′ gray level values that can save the power consumption based on the acceptable color difference range; and
applying this R′G′B′ gray levels to the pixels.

3. The method of claim 1, wherein a CIE1976Lab color system is used to transform the XYZ tristimulus values to L* value, a* value and b* value.

4. The method of claim 1, wherein the L* value and L*′ value are brightness, the a* value, b* value, a*′ value and b*′ value are chroma.

5. The method of claim 1, wherein the total color difference between the L*′ value, a*′ value, b*′ value and the L* value, a* value, b* value are [(ΔL*)²+(Δa*)²+(Δb*)²]^{1/2}, wherein ΔL*=L*′−L*, Δa*=a*′−a* and Δb*=b*′−b*.

6. The method of claim 1, wherein the acceptable color difference range is between 3 and 6.

7. The method claim 1, wherein the step of determining L*′ value, a*′ value and b*′ value further comprising:
reducing the L* value to get the L*′ value;
raising the b* value to get the b*′ value; and
reducing the a* value to get the a*′ value.

8. The method of claim 1, wherein the tristimulus values X, Y, and Z are fundamental red color, green color and blue color, respectively.
